(19) United States
(12) Patent Application Publication
(10) Pub. No.: US 2023/0408875 A1
(43) Pub. Date: Dec. 21, 2023

(54) LIQUID CRYSTAL DISPLAY DEVICE

(71) Applicant: Japan Display Inc., Tokyo (JP)

(72) Inventor: Koichiro ADACHI, Tokyo (JP)

(21) Appl. No.: 18/200,976

(22) Filed: May 23, 2023

(30) Foreign Application Priority Data
May 24, 2022 (JP) 2022-084550

(51) Int. Cl. G02F 1/1343; G02F 1/1339; G02F 1/1368; G02F 1/1362

(52) U.S. Cl. CPC G02F 1/134336; G02F 1/13394; G02F 1/133512; G02F 1/136227; G02F 1/1368

(57) ABSTRACT

A liquid crystal display device includes an array substrate including a pixel array arranged in a matrix of a plurality of pixel electrodes on an insulating layer, a counter substrate arranged with a counter electrode facing the array substrate and overlapping the plurality of pixel electrodes, a liquid crystal layer between the array substrate and the counter substrate, a first spacer between the array substrate and the counter substrate, and a protruding portion protruding into the liquid crystal layer. The counter electrode is disposed with openings in regions overlapping each of the plurality of pixel electrodes, the protruding portion is arranged in a region between the electrodes of the plurality of pixel electrodes, and a height of the protruding portion is lower than a height of the first spacer.

### CROSS-REFERENCE TO RELATED APPLICATIONS

This application claims the benefit of priority to Japanese Patent Application No. 2022-084550, filed on May 24, 2022, the entire contents of which are incorporated herein by reference.

### FIELD

An embodiment of the present invention relates to a structure of a pixel of a liquid crystal display device.

### BACKGROUND

There are two types of liquid crystal display devices: one is a transmissive type that transmits light from a backlight to display images, and the other is a reflective type that reflects external light reflected by pixel electrodes to display images. There is also a semi-transmissive liquid crystal display device that combines both reflective and transmissive structures. For example, a semi-transmissive liquid crystal display device is disclosed that displays an image using external light reflected by reflective electrodes and light from a backlight transmitted through regions between reflective electrodes (for example, Japanese Unexamined Patent Application Publication No. 2012-255908).

The liquid crystal display device disclosed in Japanese Unexamined Patent Application Publication No. 2012-255908 not only reflects external light at the reflective electrodes, but also assists the display at the reflective electrodes by transmitting light from the backlight through the space between the reflective electrodes, and is able to maintain constant luminance of the image without being affected by the surrounding environment. This liquid crystal display device uses normally black mode as a display mode to improve contrast, but further improvement of imaging quality is required.

### SUMMARY

A liquid crystal display device in an embodiment according to the present invention includes an array substrate including a pixel array arranged in a matrix of a plurality of pixel electrodes on an insulating layer, a counter substrate arranged with a counter electrode facing the array substrate and overlapping the plurality of pixel electrodes, a liquid crystal layer between the array substrate and the counter substrate, a first spacer between the array substrate and the counter substrate, and a protruding portion protruding into the liquid crystal layer. The counter electrode is disposed with openings in regions overlapping each of the plurality of pixel electrodes, the protruding portion is arranged in a region between the electrodes of the plurality of pixel electrodes, and a height of the protruding portion is lower than a height of the first spacer.

A liquid crystal display device in an embodiment according to the present invention includes an array substrate including a pixel array having a plurality of pixel electrodes arranged in a matrix on an insulating layer, a counter substrate opposite the array substrate and including a counter electrode overlapping the plurality of pixel electrodes, and a liquid crystal layer between the array substrate and the counter substrate. The counter electrode includes first openings overlapping each of the plurality of pixel electrodes, and second openings overlapping regions between pixels of the plurality of pixel electrodes.

A liquid crystal display device in an embodiment according to the present invention includes an array substrate including a pixel array having a plurality of pixel electrodes arranged in a row and column direction on an insulating layer, a counter substrate opposite the array substrate and including a counter electrode overlapping the plurality of pixel electrodes, a liquid crystal layer between the array substrate and the counter substrate, and a first spacer between the array substrate and the counter substrate. The counter electrode includes first openings overlapping each of the plurality of pixel electrodes; and second openings overlapping regions between pixels of the plurality of pixel electrodes. The first spacers are arranged in a first region between pixel electrodes of the plurality of pixel electrodes and in a direction along a diagonal of the pixel array, and the second openings are arranged in a region between the plurality of pixel electrodes and between the pixel electrodes along the array of the first spacers.

### BRIEF DESCRIPTION OF DRAWINGS

FIG. 1 is a configuration of a liquid crystal display device according to an embodiment of the present invention.

FIG. 2 is a configuration of a pixel circuit and pixel electrodes connected to the pixel circuit which constitute a pixel of a liquid crystal display device according to an embodiment of the present invention.

FIG. 3 is a plan view of a pixel array of a liquid crystal display device according to an embodiment of the invention.

FIG. 4 is a cross sectional view of a pixel of a liquid crystal display device according to an embodiment of the present invention.

FIG. 5 is a plan view of a structure and arrangement of pixel electrodes and an orientation state of liquid crystal molecules in a liquid crystal display device according to an embodiment of the present invention.

FIG. 6 is a cross sectional view of a pixel of a liquid crystal display device according to an embodiment of the present invention.

FIG. 7 is a plan view of a structure and arrangement of pixel electrodes and an orientation state of liquid crystal molecules in a liquid crystal display device according to an embodiment of the present invention.

FIG. 8 is a plan view of a structure and arrangement of pixel electrodes and an orientation state of liquid crystal molecules in a liquid crystal display device according to an embodiment of the present invention.

FIG. 9 is a plan view of a structure and arrangement of pixel electrodes and an orientation state of liquid crystal molecules in a liquid crystal display device according to an embodiment of the present invention.

FIG. 10 is a cross sectional view of a pixel of a liquid crystal display device according to an embodiment of the present invention.

FIG. 11 is a plan view of a structure and arrangement of pixel electrodes and an orientation state of liquid crystal molecules in a liquid crystal display device according to an embodiment of the present invention.

FIG. 12 is a plan view of a structure and arrangement of pixel electrodes and an orientation state of liquid crystal molecules in a liquid crystal display device according to an embodiment of the present invention.

FIG. 13 is a cross sectional view of a pixel of a liquid crystal display device according to an embodiment of the present invention.

FIG. 14 is a plan view of a structure and arrangement of pixel electrodes and an orientation state of liquid crystal molecules in a liquid crystal display device according to an embodiment of the present invention.

FIG. 15 is a plan view of a structure and arrangement of pixel electrodes and an orientation state of liquid crystal molecules in a liquid crystal display device according to an embodiment of the present invention.

FIG. 16 is a plan view of a structure and arrangement of pixel electrodes and an orientation state of liquid crystal molecules in a liquid crystal display device according to an embodiment of the present invention.

FIG. 17 is a cross sectional view of a pixel of a liquid crystal display device according to an embodiment of the present invention.

FIG. 18 is a partial cross-sectional view of a pixel of a liquid crystal display.

FIG. 19 is a plan view of a structure and arrangement of pixel electrodes and an orientation state of liquid crystal molecules in a liquid crystal display device.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to the previous drawing may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### Liquid Crystal Display Device

This embodiment, as an example, describes a MIP (Memory in Pixel) type liquid crystal display device that incorporates a memory circuit to store data for each pixel.

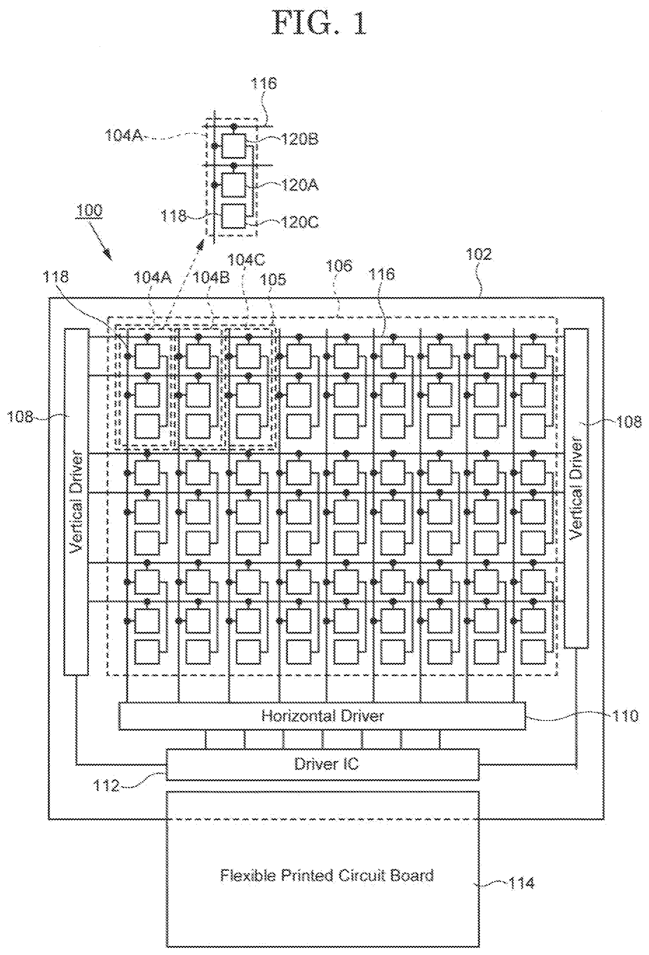

FIG. 1 shows a liquid crystal display device 100. The liquid crystal display device 100 includes a pixel array 106 in which pixels 105 are arranged. The pixel array 106 is disposed, for example, on a transparent glass substrate. In this embodiment, the substrate disposed with the pixel array 106 is referred to as the array substrate 102. The array substrate 102 is disposed with a driver circuit that drives the pixel array 106. The driver circuits include a vertical driver 108, a horizontal driver 110, and a driver IC 112. These driver circuits are disposed in an area outside of the pixel array 106 on the array substrate 102.

The pixel array 106 is arranged with pixels 105 in a row and column direction. The pixel array 106 is disposed with a plurality of scanning signal lines 116 in the row direction and a plurality of data signal lines 118 in the column direction, corresponding to the array of pixels 105.

The pixel 105 includes a plurality of sub-pixels. FIG. 1 shows that the pixel 105 includes a first sub-pixel 104A, a second sub-pixel 104B, and a third sub-pixel 104C. As described below, since the liquid crystal display device 100 displays images in area gradation, one sub-pixel is composed of a plurality of divided pixel electrodes. FIG. 1 shows that the first sub-pixel 104A includes a first pixel electrode 120A, a second pixel electrode 120B, and a third pixel electrode 120C. The second sub-pixel 104B and the third sub-pixel 104C have a similar configuration.

The vertical driver 108 outputs scanning signals to the scanning signal lines 116 arranged in the pixel array 106. The pixels 105 arranged in the pixel array 106 are selected for each row, and the first sub-pixel 104A, second sub-pixel 104B, and third sub-pixel 104C of the selected pixels 105 are in the signal writing state and the data signals (video signals) are written from the plurality of data signal lines 118. The vertical driver 108 outputs selection pulses sequentially to the plurality of scanning signal lines 116 and operates so that data is written every frame. The vertical driver 108 can also operate to rewrite the data of the pixels 105 belonging to a specific area by addressing them in row units. Although FIG. 1 shows a configuration in which the vertical driver 108 is disposed on both the left and right sides of the pixel array 106, the vertical driver 108 is not limited to this example and may be disposed on only one side of the pixel array 106.

The horizontal driver 110 outputs data signals output from the driver IC 112 to the plurality of data signal lines 118. The horizontal driver 110 includes a multiplexer circuit and selects the plurality of data signal lines 118 to output data signals. Various writing methods of data signals by the horizontal driver 110 can be adopted, such as a line sequential method in which data signals are written simultaneously to the pixels 105 in the selected rows, or a point sequential method in which data signals are written sequentially per pixel to the pixels 105 in the selected rows, and so on.

The driver IC 112 is formed, for example, by a semiconductor integrated circuit. For example, the driver IC 112 may be mounted on the array substrate 102 in a COG (chip on glass) method or on a flexible printed circuit board 114 in a COF (chip on film) method as shown in the figure. The driver IC 112 outputs data signals for displaying images to the horizontal driver 110, and outputs timing signals to the vertical driver 108 to synchronize with the data signals.

A flexible printed circuit board 114 is attached to the array substrate 102. The data signals and the control signals to be input to the driver IC 112 are input from an external controller (not shown) via the flexible printed circuit board 114.

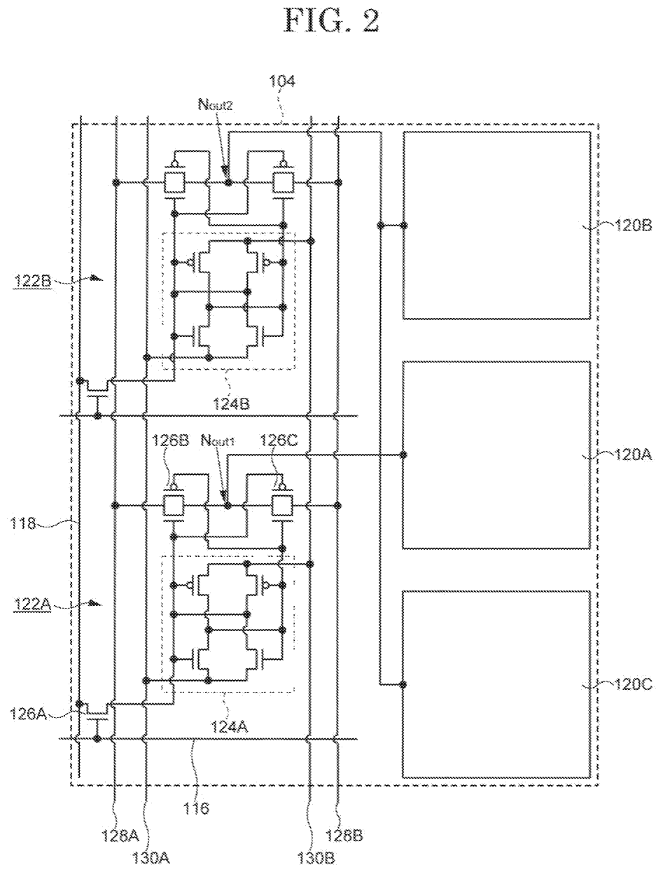

FIG. 2 shows the pixel electrode and circuit configuration of the sub-pixel 104 that conforms to the area gradation. The sub-pixel 104 includes a first pixel circuit 122A and a second pixel circuit 122B. The first pixel circuit 122A is connected to the first pixel electrode 120A, and the second pixel circuit 122B is connected to the second pixel electrode 120B and the third pixel electrode 120C.

The first pixel electrode 120A, the second pixel electrode 120B, and the third pixel electrode 120C have the same area. The sub-pixel 104 includes the first pixel electrode 120A disposed in the center, and the second pixel electrode 120B and the third pixel electrode 120C are disposed on both sides of the first pixel electrode 120A.

The first pixel circuit 122A is connected to the first pixel electrode 120A, and the second pixel circuit 122B is connected to the second pixel electrode 120B and the third pixel electrode 120C. The sub-pixel 104 is substantially composed of two pixel electrodes: the first pixel electrode 120A and a pair of pixel electrodes by the second pixel electrode 120B and the third pixel electrode 120C, resulting in an area ratio of pixel electrodes of 1:2 and weighting of the area of the pixel electrodes.

The sub-pixel 104 shown in FIG. 2 has three pixel electrodes, but is essentially composed of two pixel electrodes of different areas. The first sub-pixel 104A, second sub-pixel 104B, and third sub-pixel 104C, which constitute pixel 105, are disposed such that the first pixel electrode 120A is disposed in the center and the second pixel electrode 120B and third pixel electrode 120C are disposed on either side of the center. This arrangement can align the center of gravity of each tone with respect to the center of gravity of a single pixel.

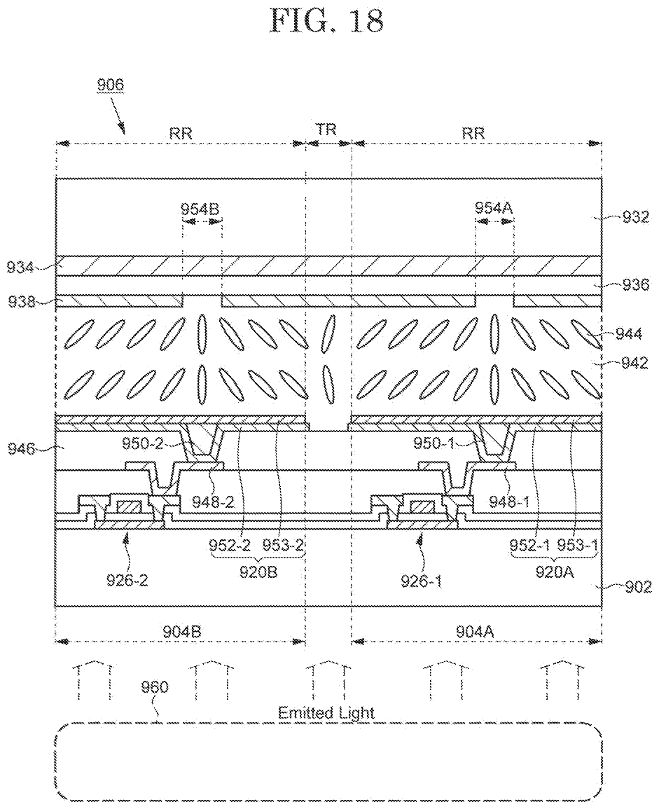

As shown in FIG. 2, the first pixel circuit 122A includes a first switching element 126A, a second switching element 126B, a third switching element 126C, and a first latch circuit 124A. The first switching element 126A is formed, for example, of a thin-film transistor, the gate of which is connected to the scanning signal line 116, and one of the input/output terminals consisting of a source and a drain is connected to the data signal line 118. When a scanning signal is applied to the gate from the scanning signal line 116, the first switching element 126A is turned on and a data signal is input to the first latch circuit 124A from the data signal line 118. A second switching element 126B is disposed between the first control signal line 128A, to which a control signal of the same polarity as the voltage of the opposite electrode 138 (see FIG. 18) is applied, and the output node Nₒᵤₜ₁ of the first pixel circuit 122A. The third switching element 126C is disposed between a second control signal line 128B, to which a control signal of the reversed phase from the first control signal line 128A is applied, and the output node Nₒᵤₜ₁. The first latch circuit 124A is connected to the first power supply line 130A, to which a high potential power supply voltage is applied, and to the second power supply line 130B to which a low potential power supply voltage is applied.

One of the second switching element 126B and the third switching element 126C is turned on and the other is turned off according to the polarity of the voltage held in the first latch circuit 124A. One of the input/output terminals of the second switching element 126B is connected to one of the input/output terminals of the third switching element 126C. That node is the output node Nₒᵤₜ₁ of the first pixel circuit 122A. The output node Nₒᵤₜ₁ is connected to the first pixel electrode 120A.

The second pixel circuit 122B has the same circuit configuration as the first pixel circuit 122A and operates similarly. The output node Nₒᵤₜ₂ of the second pixel circuit 122B is connected to the second pixel electrode 120B and the third pixel electrode 120C, and outputs a voltage of the same polarity or reverse polarity as the common voltage to these two pixel electrodes.

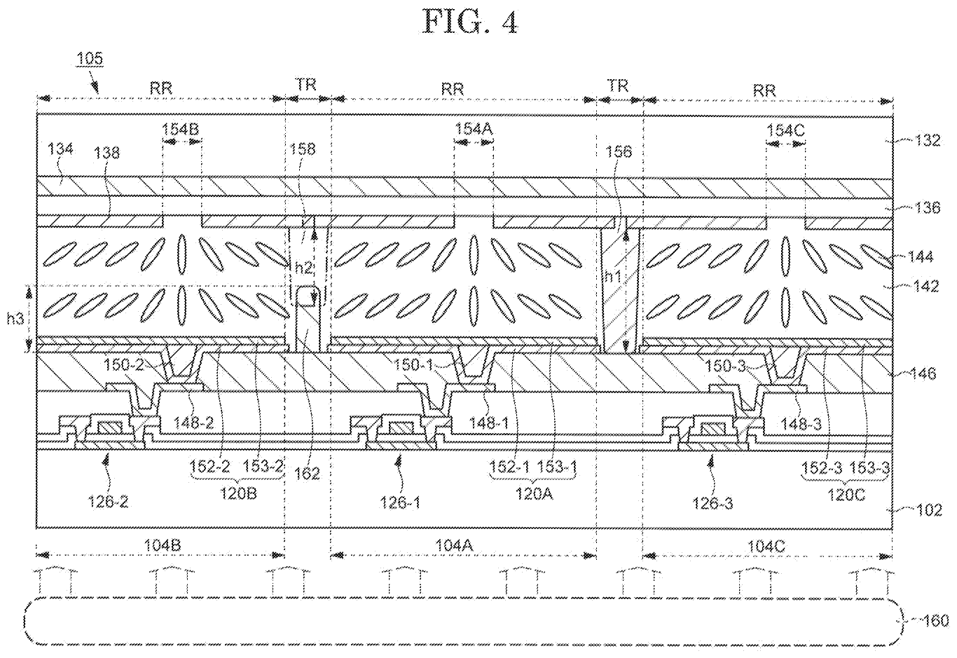

The liquid crystal display device 100 in the present embodiment is applied with a vertically aligned (VA: Vertical Alignment) liquid crystal. The liquid crystal layer is disposed between the first pixel electrode 120A, the second pixel electrode 120B, and the third pixel electrode 120C, and the counter electrode 138 (refer to FIG. 4) disposed opposite to these pixel electrodes. When a predetermined common voltage is applied to the counter electrode 138, a voltage of the same polarity or reverse polarity as the common voltage is applied to the first pixel electrode 120A from the first pixel circuit 122A. In other words, one of the second switching element 126B and the third switching element 126C is turned on and a voltage of the same polarity or reverse polarity as the common voltage is output from output node Nₒᵤₜ₁, according to the voltage based on the data signal held by the first latch circuit 124A.

FIG. 18 shows an example of a partial cross-sectional structure of a pixel array 906 of a liquid crystal display device to which a vertically aligned liquid crystal is applied. FIG. 18 shows the cross-sectional structure of a first pixel electrode 920A and a second pixel electrode 920B, and a counter electrode 930, and the boundary portion of these electrodes. The liquid crystal layer 942 is disposed between the array substrate 902 and the counter substrate 932. The array substrate 902 is disposed with the first pixel electrode 920A and the second pixel electrode 920B, and the counter substrate 932 is disposed with the counter electrode 938.

The first pixel electrode 920A and the second pixel electrode 920B are disposed on an insulating layer 946. The first pixel electrode 920A and the second pixel electrode 920B are connected to switching elements 926-1, 926-2 via connection wirings 948-1, 948-2, respectively. The first and second pixel electrodes 920A, 920B may be disposed with fillers 950-1, 950-2 so that no steps are formed at the region of contact holes in the insulating layer 946.

The first pixel electrode 920A and the second pixel electrode 920B are reflective electrodes. The first pixel electrode 920A and the second pixel electrode 920B may have a structure in which first conductive layers 952-1, 952-2 formed of a transparent conductive material and second conductive layers 953-1, 953-2 formed of a metal material are laminated.

A color filter layer 934, an overcoat layer 936, and a counter electrode 938 are disposed on the counter substrate 932. The counter electrode 938 is formed of a transparent conductive film such as ITO and has a size that extends over the entire pixel array 906. The counter electrode 938 is disposed with a first opening 954A in a region overlapping the first pixel electrode 920A and a second opening 954B in a region overlapping the second pixel electrode 920B.

The first pixel electrode 920A and the second pixel electrode 920B are reflective electrodes and reflect external light incident from the counter substrate 932. The presence or absence of reflected light emitted from the counter substrate 932 and its light intensity are controlled by the orientation state of the liquid crystal molecules 944 in the liquid crystal layer 942.

The pixel array 906 has a reflection region RR formed by the first pixel electrode 920A and the second pixel electrode 920B and a transmission region TR between the first pixel electrode 920A and the second pixel electrode 920B. The transmission region TR is a region between the edge of the second conductive layer 953-1, which constitutes the first pixel electrode 920A, and the edge of the second conductive layer 953-2, which constitutes the second pixel electrode 920B. A backlight 960 is disposed on the array substrate 902 side. An image is displayed on the pixel array 906 by the reflected light from the first pixel electrode 920A and second pixel electrode 920B in the reflection region RR and the light from the backlight 960 passing through the transmission region TR.

As shown in FIG. 18, since the transmission region RT in which a light shielding layer that shields the region between pixels is not arranged in the pixel array 906 is designated as the display region, any orientation disorder in the liquid crystal molecules in the region between the first pixel electrode 920A and the second pixel electrode 920B may affect the picture quality.

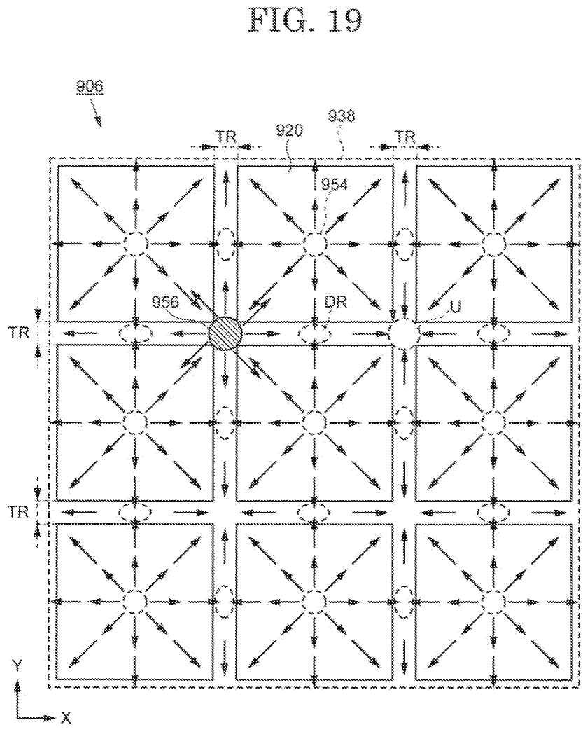

FIG. 19 shows a schematic plan view of the pixel array 906, in which the plurality of pixel electrodes 920 are arranged in a matrix in the x-axis and y-axis directions shown in the figure. The pixel electrodes 920 shown in FIG. 19 are square in a plan view. The dotted circle overlaying the pixel electrode 920 indicates the opening 954 of the counter electrode 938. FIG. 19 also shows that a spacer 956 is disposed in a region surrounded by the four pixel electrodes 920.

FIG. 19 shows the orientation direction of the liquid crystal molecules by means of arrows. As explained with reference to FIG. 18, the liquid crystal molecules are aligned radially around the opening 954 when a potential difference is generated between the pixel electrode 920 and the counter electrode 938. Although the liquid crystal molecules are radially oriented on the pixel electrode 920, the orientation state becomes unstable in the transmission region TR between the pixel electrodes due to mutual interference of liquid crystal molecules that are aligned from both sides. As a result, as shown in FIG. 19, the region DR near the center of one side of the pixel electrode 920 and adjacent to the neighboring pixel electrode is a region that induces orientation disorder (disclination) of the liquid crystal molecules. This region DR is observed between the pixel electrodes arrayed in a matrix as shown in FIG. 19. Therefore, when orientation disorder occurs in many regions DR, it may affect the displayed image and cause display unevenness when viewed on the entire screen, which may be visible by the user.

On the other hand, since the liquid crystal molecules are equally aligned from four or eight directions in regions U surrounded by the edges of the four pixel electrodes 920, and since no electric field is generated in that region, the orientation state is relatively stable. Also, since the orientation of the liquid crystal molecules is controlled by the effect of the spacer 956 in the region where the spacer 956 is disposed, orientation disorder is less likely to occur. While the region DR is affected by the liquid crystal molecules oriented on each electrode, it is far enough away from the region U where the orientation of the liquid crystal molecules is stable compared to the size of the liquid crystal molecules, which causes the orientation state to be unstable.

The liquid crystal display device 100 in the present embodiment has a reflection region RR that overlaps the pixel electrodes and a transmission region TR between pixels, and the image is displayed using both of these regions. Therefore, if orientation disorder occurs in the region DR, it may adversely affect the image quality. The liquid crystal display device 100 of the present embodiment has the pixel array configuration shown in the embodiment below to prevent the occurrence of orientation disorder and suppress the degradation of image quality.

### First Embodiment

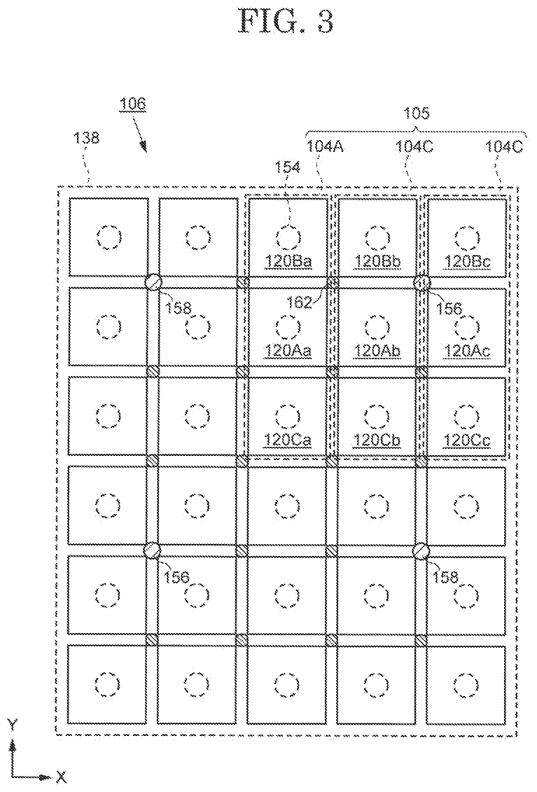

FIG. 3 shows a plan view of the pixel array 106. FIG. 3 shows a configuration in which the pixel 105 includes three sub-pixels (first sub-pixel 104A, second sub-pixel 104B, and third sub-pixel 104C). The first sub-pixel 104A is disposed of a first pixel electrode 120Aa, and a second pixel electrode 120Ba and a third pixel electrode 120Ca that sandwich the first pixel electrode 120Aa. The first sub-pixel 104A is disposed with the first pixel circuit 122A and the second pixel circuit 122B shown in FIG. 2. The first pixel circuit 122A is connected to the first pixel electrode 120Aa, and the second pixel circuit 122B is connected to the second pixel electrode 120Ba and the third pixel electrode 120Ca. The second sub-pixel 104B is disposed with a first pixel electrode 120Ab, a second pixel electrode 120Bb and a third pixel electrode 120Cb, and the third sub-pixel 104C is disposed with a first pixel electrode 120Ac, a second pixel electrode 120Bc and a third pixel electrode 120Cc, and each having a similar configuration as the first sub-pixel 104A.

As shown in FIG. 3, the first pixel electrode 120Aa, the second pixel electrode 120Ba, and the third pixel electrode 120Ca of the first sub-pixel 104A have a square shape in a plan view. The first spacer 156 is disposed in a region between some pixels of the pixel array 106. A second spacer 158 is disposed in a region between some pixels distant from the first spacer 156. The first spacer 156 and the second spacer 158 are disposed at a distance in the pixel array 106 so that a plurality of sub-pixels is interposed between them. The first spacer 156 is a columnar structure provided to maintain the cell gap of the liquid crystal cell, and the second spacer 158 is a structure provided to suppress changes in the cell gap even when an external force acts to reduce the cell gap.

The pixel array 106 is disposed with protruding portions 162 in the regions between pixels. The protruding portions 162 are arranged in regions other than the regions where the first spacer 156 and the second spacer 158 are arranged and where the corners of the four pixel electrodes are adjacent. For example, the protruding portions 162 are arranged in a region surrounded by the corner portions of the first pixel electrode 120Aa, the second pixel electrode 120Ba, the first pixel electrode 120Ab, and the second pixel electrode 120Bb. It is preferred that such protruding portions 162 be arranged in regions between pixels in the pixel array except where the first spacer 156 is arranged.

FIG. 4 shows a cross-sectional structure of pixel 105 in the liquid crystal display device 100. Specifically, FIG. 4 shows the cross-sectional structure of the first sub-pixel 104A and partial cross-sectional structures of the second sub-pixel 104B and the third sub-pixel 104C. The first sub-pixel 104A includes the first pixel electrode 120A, the second sub-pixel 104B includes the second pixel electrode 120B, and the third sub-pixel 104C includes the third pixel electrode 120C. The first pixel electrode 120A, the second pixel electrode 120B, and the third pixel electrode 120C are disposed on the array substrate 102. The counter substrate 132 is disposed opposite the array substrate 102. The counter substrate 132 is disposed with the counter electrode 138. The counter electrode 138 is disposed opposite the first pixel electrode 120A, the second pixel electrode 120B, and the third pixel electrode 120C. The liquid crystal layer 142 is disposed between the array substrate 102 and the counter substrate 132 (or, in other words, between the first pixel electrode 120A, the second pixel electrode 120B, and the third pixel electrode 120C and the counter electrode 138).

The first pixel electrode 120A, the second pixel electrode 120B, and the third pixel electrode 120C are disposed on an insulating layer 146. The first pixel electrode 120A is connected to a switching element 126-1 (corresponding to the second switching element 126B or the third switching element 126C shown in FIG. 2) via a connecting wiring 148-1. The second pixel electrode 120B is connected to a switching element 126-2 via a connecting wiring 148-2, and the third pixel electrode 120C is connected to a switching element 126-3 via a connecting wiring 148-3. The switching elements 126-2, 126-3 have the same function as the switching element 126-1. The connection wiring 148-1 is an intermediate wiring that connects the switching element 126-1 to the first pixel electrode 120A, the connection wiring 148-2 is an intermediate wiring that connects the switching element 126-2 to the second pixel electrode 120B, and the connection wiring 148-3 is an intermediate wiring that connects the switching element 126-3 to the second pixel electrode 126-4.

The first pixel electrode 120A, the second pixel electrode 120B, and the third pixel electrode 120C are connected to the connection wirings 148-1, 148-2, 148-3 via contact holes formed in the insulation layer 148. Recess regions resulting from the contact holes are formed in the portion where the first pixel electrode 120A, the second pixel electrode 120B, and the third pixel electrode 120C are connected to the connecting wirings 148-1, 148-2, 148-3. Fillers 150-1, 150-2, and 150-3 may disposed to fill these recess regions. The fillers 150-1, 150-2, 150-3 flatten the recess regions caused by the formation of contact holes, and can prevent orientation disorder of liquid crystal molecules in these regions.

Although not shown in FIG. 4, a microscopic uneven structure may be formed on the surface of the first pixel electrode 120A, the second pixel electrode 120B, and the third pixel electrode 120C to dispose a light scattering function. The fine uneven structure may be formed by making the surface of the insulating layer 146 uneven.

The first pixel electrode 120A, the second pixel electrode 120B, and the third pixel electrode 120C are reflective electrodes. The reflective electrodes have a reflective surface formed by a metal film. The reflective electrode may have a single layer, or it may have a stacked structure with a plurality of conductive layers of different materials. For example, the first pixel electrode 120A, the second pixel electrode 120B, and the third pixel electrode 120C are formed of first conductive layers 152-1, 152-2, 152-3 connected to the connecting wirings 148-1, 148-2, 148-3, and second conductive layers 153-1, 153-2, 153-3 which are formed from the top of the first conductive layers 152-1, 152-2, 152-3 to cover the fillers 150-1, 150-2, 150-3.

The first conductive layers 152-1, 152-2, 152-3 are preferably formed of a transparent conductive material such as ITO (Indium Tin Oxide), and the second conductive layers 153-1, 153-2, 153-3 are preferably formed of a light-reflective metal film such as aluminum. This combination of materials can form a good electrical connection between the first pixel electrode 120A, second pixel electrode 120B, and third pixel electrode 120C and the connecting wirings 148-1, 148-2, 148-3, and can be made to function as reflective electrodes. For the first pixel electrode 120A, the second pixel electrode 120B, and the third pixel electrode 120C, the edges of the second conductive layers 153-1, 153-2, 153-3 may coincide with the edges of the first conductive layer 152-1, 152-2, 152-3 or edges of the second conductive layers 153-1, 153-2, 153-3 may recede inward from the edges of the first conductive layers 152-1, 152-2, 152-3 as shown in FIG. 4.

A color filter layer 134, an overcoat layer 136, and the counter electrode 138 are disposed on the counter substrate 132. The counter electrode 138 is formed of a transparent conductive film such as ITO and is disposed to cover the plurality of pixel electrodes. The counter electrode 138 is arranged with a first opening 154A in a region overlapping the first pixel electrode 120A, a second opening 154B in a region overlapping the second pixel electrode 120B, and a third opening 154C in a region overlapping the third pixel electrode 120C.

The external light that enters from the counter substrate 132 side and passes through a polarizer (not shown), the color filter layer 134, the transparent overcoat layer 136, the counter electrode 138, and the liquid crystal layer 142 is reflected by the first pixel electrode 120A, the second pixel electrode 120B, and the third pixel electrode 120C. The reflected light follows a path opposite to that of the incident light and is emitted from the counter substrate 132. The presence or absence of the reflected light emitted from the counter substrate 132 and its light intensity is controlled by the orientation state of the liquid crystal molecules 144 in the liquid crystal layer 142.

The pixel array 106 has the reflection region RR formed by the first pixel electrode 120A, the second pixel electrode 120B, and the third pixel electrode 120C, and the transmission region TR between these pixel electrodes. The transmission region TR is defined by a region between the edge of the second conductive layer (metal film) 153-1, which constitutes the first pixel electrode 120A, the edge of the second conductive layer (metal film) 153-2, which constitutes the second pixel electrode 120B, and the edge of the second conductive layer (metal film) 153-3, which constitutes the third pixel electrode 120C. In order to use the transmission region TR as a display region for the transmission mode, the backlight 160 is disposed on the back side of the array substrate 102 (opposite the side on which the first pixel electrode 120A, the second pixel electrode 120B, and the third pixel electrode 120C are disposed).

The liquid crystal display device 100 in the present embodiment displays images in reflection mode in the reflection region RR and in transmission mode in the transmission region TR. It is possible to compensate for luminance by emitting light from the backlight 160 through the transmission region TR. For example, a bright image cannot be displayed by the reflection mode in a dark place, but the image can be displayed brighter by combining the transmission mode.

Although omitted in FIG. 4, the array substrate 102 and the counter substrate 132 are disposed with a vertically orientation membrane. With the vertically aligned film, the liquid crystal molecules 144 are vertically oriented when no voltage is applied between the first pixel electrode 120A, second pixel electrode 120B, and third pixel electrode 120C and the counter electrode 138. In other words, the long axis of the liquid crystal molecules 144 is aligned such that it is standing perpendicular to the substrate surface of the array substrate 102. When a predetermined voltage is applied between the first pixel electrode 120A and the second pixel electrode 120B and the counter electrode 138, the long axis of the liquid crystal molecules 144 is tilted horizontally and aligned horizontally when the maximum voltage is applied.

Since no electric field is formed at the edges of the first opening 154A, the second opening 154B, and the third opening 154C disposed in the counter electrode 138, the liquid crystal molecules at the positions overlapping the said openings maintain a vertically oriented state. FIG. 4 schematically shows the state in which the liquid crystal molecules around the first opening 154A, the second opening 154B, and the third opening 154C are diagonally aligned between the liquid crystal molecules that are aligned in the horizontal direction and those that maintain a vertical orientation state.

FIG. 4 also shows the first spacer 156, the second spacer 158, and the protruding portion 162. As explained with reference to FIG. 3, the second spacer 158 is disposed in a region between pixels that does not actually overlap the protruding portion 162. FIG. 4 shows the second spacer 158 as a double-dashed line for illustration. The first spacer 156 and the second spacer 158 are disposed on either the array substrate 102 or the counter substrate 132. The first spacer 156 contacts both the array substrate 102 and the counter substrate 132, and the second spacer 158 is a spacer that contacts either the array substrate 102 or the counter substrate 132. Therefore, as shown in FIG. 4, a height h1 of the first spacer 156 is higher than a height h2 of the second spacer 158, and the relationship is h1>h2. Because of this relationship, the first spacer 156 is sometimes referred to as the main spacer and the second spacer 158 as the sub-spacer.

As explained with reference to FIG. 19, the orientation disorder (disclination) may occur in the region between pixels, which may affect the image quality. The liquid crystal display device 100 of the present embodiment has a structure in which protruding portions 162 are arranged in the region where the corner portions of the four pixel electrodes are adjacent to each other. The protruding portions 162 are arranged to protrude from the insulating layer 146 into the liquid crystal layer 142. A height h3 of the protruding portion 162 is lower than the height h1 of the first spacer 156. The height h3 of the protruding portion 162 is preferably lower than the height h2 of the second spacer 158. In other words, the height h3 of the protruding portion 162 may have a height of approximately half of the cell gap (approximately half of the height h1 of the first spacer 156). Although the protruding portion 162 plunges into the liquid crystal layer 142, it does not reach the counter substrate 132. The protruding portion 162 does not have a height that affects the cell gap of the liquid crystal cell, but it is arranged to plunge into the liquid crystal layer 142 and has a function of regulating the orientation of the liquid crystal molecules 144.

Although not shown in FIG. 4, a surface of the protruding portion 162 is covered with the orientation membrane. The orientation of the liquid crystal molecules 144 around the protruding portion 162 is regulated by the protruding portion 162, and furthermore, the orientation state of the liquid crystal molecules 144 around the protruding portion 162 is also stabilized. Therefore, orientation is also controlled in the region between pixels, and the occurrence of orientation disorder is prevented.

The protruding portions 162 may be provided in a continuous structure from the insulating layer 146 or as a separate structure from the insulating layer 146. For example, the protruding portions 162 may be formed by etching back the insulating layer 146, which has a flat surface, so that the portions that are protrusions remain. The protruding portions 162 may also be formed by depositing a new insulating layer on the insulating layer 146 by patterning. There is no limitation on the material of the protruding portion 162, and organic or inorganic insulating materials may be used, and the protruding portion 162 may be formed using a metallic material when the structure is not in contact with the pixel electrode.

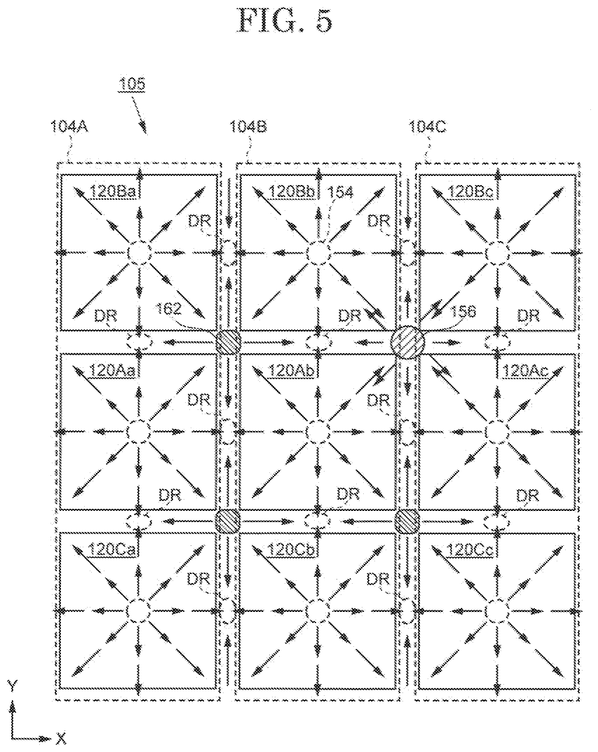

FIG. 5 shows a plan view of the pixel 105. The pixel array 106 includes the first sub-pixel 104A, the second sub-pixel 1046, and the third sub-pixel 104C. These sub-pixels have the same cross-sectional structure shown in FIG. 4. The first spacer 156 is disposed in a region where the corners of the four pixel electrodes are adjacent to each other. The first spacers 156 are disposed discretely in the pixel array 106. In this embodiment, the protruding portions 162 are arranged in regions where the first spacer 156 is not disposed in regions where the corner portions of the four pixel electrodes are adjacent. For example, the first spacer 156 is disposed in a region between pixels surrounded by the first pixel electrodes 120Ab, 120Ac and the second pixel electrodes 120Bb, 120Bc. The protruding portion 162 is arranged in a region between pixels surrounded by the first pixel electrodes 120Aa, 120Ab, and the second pixel electrodes 120Ba, 120Bb.

FIG. 5 also schematically shows the orientation state of the liquid crystal molecules by means of arrows. As explained with reference to FIG. 19, the liquid crystal molecules are aligned radially around the opening 154 arranged in the counter electrode. The liquid crystal molecules are aligned in the region DR where the outer edges of the pixel electrodes are adjacent to each other, so that the liquid crystal molecules collide with each other from both sides. However, the orientation of the liquid crystal molecules is regulated starting from the protruding portion 162, in the region between the pixel electrodes. Specifically, the liquid crystal molecules are aligned radially starting from the protruding portion 162. The orientation regulating force of the protruding portion 162 also acts on the region DR. As a result, the occurrence of orientation disorder in the region DR is controlled. Similarly, the orientation state of the liquid crystal molecules is regulated in the region between the pixels in which the first spacer 156 is disposed.

As described above, the orientation state of the liquid crystal molecules can be regulated regardless of the potential difference between the pixel electrode and the opposite electrode, by providing structures (the first spacer 156 and the protruding portion 162) in the liquid crystal layer 142. The liquid crystal molecules in the region DR can also be subjected to the effect of the orientation regulating force by the structures (the first spacer 156 and the protruding portion 162), by providing such structures (the first spacer 156 and the protruding portion 162) in the vicinity of the region DR where orientation disorder between pixels is likely to occur, thereby enhancing the degree of stability. The spacer is used in the liquid crystal display device to maintain the cell gap. Therefore, although it possible to form all the structures with the first spacer 156, if this is done, the repulsive force of the liquid crystal cell becomes stronger and impact bubbles are more likely to be generated in the liquid crystal layer. Therefore, it is possible to provide a high-density structure in a region between pixels surrounded by four pixel electrodes by using the protruding portion 162 as shown in the present embodiment.

The shape of the protruding portion 162 in a plan view is not limited to the shape shown in the figure, and may be circular, triangular, diamond-shaped, cross-shaped, star-shaped, or polygonal, such as hexagonal or octagonal, in a plan view.

As shown in this embodiment, the orientation disorder that occurs in regions between pixels where the pixel electrodes are adjacent to each other vertically or horizontally can be suppressed, by providing the protruding portions 162 in regions where the four pixel electrodes are adjacent to each other. As a result, the orientation disorder of liquid crystal molecules can be controlled even in the regions between pixels that are displayed in transmission mode, thereby reducing the degradation of image quality.

The liquid crystal display device 100 of the present embodiment has a memory circuit (latch circuit 124) that stores data signals in the sub-pixel 104, and can display images based on the data signals stored in the memory circuit. The sub-pixel 104 which includes three pixel electrodes (first sub-pixel 104A, second sub-pixel 104B, and third sub-pixel 104C) are composed of reflective electrodes, and the gradation is expressed by area gradation using these reflective electrodes. In addition to displaying images in reflection mode, the liquid crystal display device 100 of the present embodiment can display images in combination with transmission mode, in which a region between the sub-pixels is used as the transmission region TR and light from the backlight 160 is transmitted through the region.

### Second Embodiment

This embodiment shows a form in which the configuration of the protruding portion differs from the first embodiment. In the following description, details will focus on the parts that differ from the first embodiment, and common parts will be omitted from the explanation as appropriate.

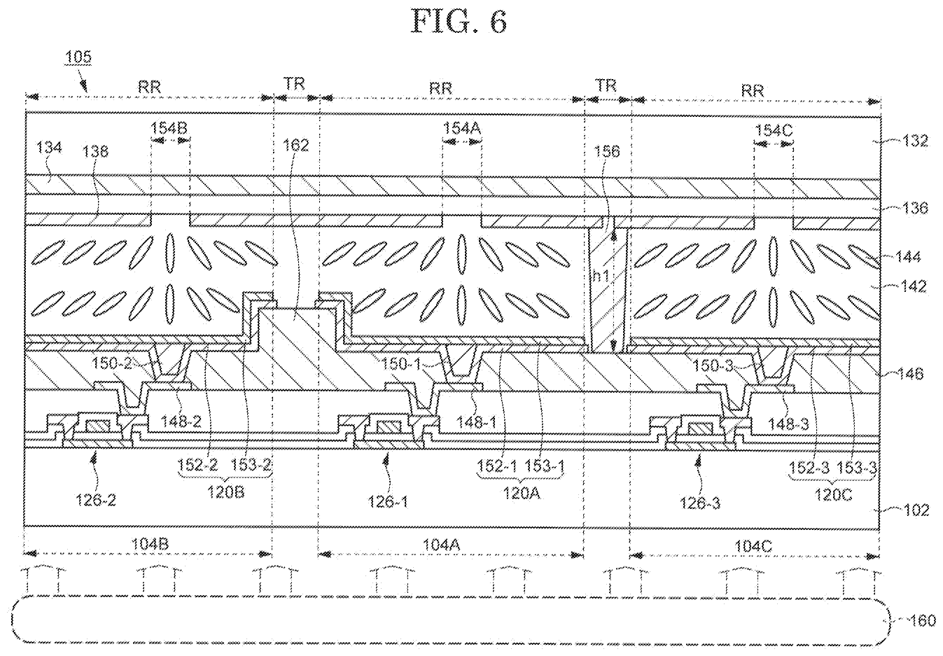

FIG. 6 shows a cross-sectional structure of a pixel 105 of the present embodiment, specifically, the cross-sectional structure of the first sub-pixel 104A and partial cross-sectional structures of the second sub-pixel 1046 and the third sub-pixel 104C. As shown in FIG. 6, the protruding portion 162 is arranged in the transparent region TR between the first pixel electrode 120A and the second pixel electrode 120B. The protruding portion 162 is wider than the structure shown in the first embodiment, and the edges of the first pixel electrode 120A and the second pixel electrode 120B overlap the protruding portion 162. In other words, the edge (corner) of the first pixel electrode 120A and the edge (corner) of the second pixel electrode 120B are disposed so that they are raised above the protruding portion 162.

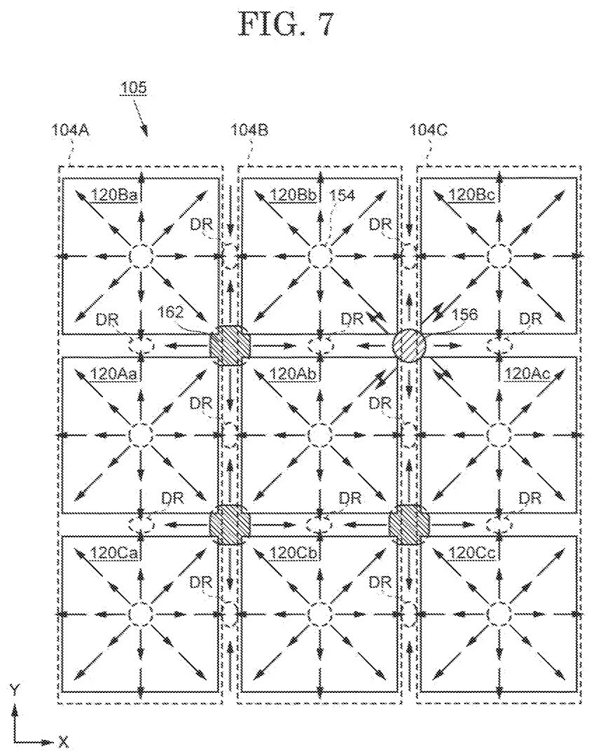

FIG. 7 shows a plan view of the pixel 105 of the liquid crystal display. As shown in FIG. 7, the adjacent corners of the four pixel electrodes overlap on the protruding portions 162. For example, the adjacent corners of the first pixel electrodes 120Aa and 120Ab and the second pixel electrodes 120Ba, 120Bb are disposed so that they overlap each other on top of the protruding portions 162.

As described in the first embodiment, the protruding portions 162 have the function of regulating the orientation of the liquid crystal molecules. The liquid crystal molecules are aligned radially from the protruding portions 162. In this embodiment, the widened width of the protruding portion 162 allows the orientation regulating force by the protruding portion 162 to act more effectively on the region DR between the pixel electrode and the electrode sandwiched between one edge and another edge of the pixel electrode adjacent thereto.

The liquid crystal display device of the present embodiment is similar to that in the first embodiment except that the configuration of the protruding portion 162 is different, and the same advantageous effects are achieved. Thereby, the image quality can be improved in a display that combines reflection mode and transmission mode.

### Third Embodiment

This embodiment shows a form in which the configuration of the protruding portion differs from the first embodiment. In the following description, details will focus on the parts that differ from the first embodiment, and common parts will be omitted from explanation as appropriate.

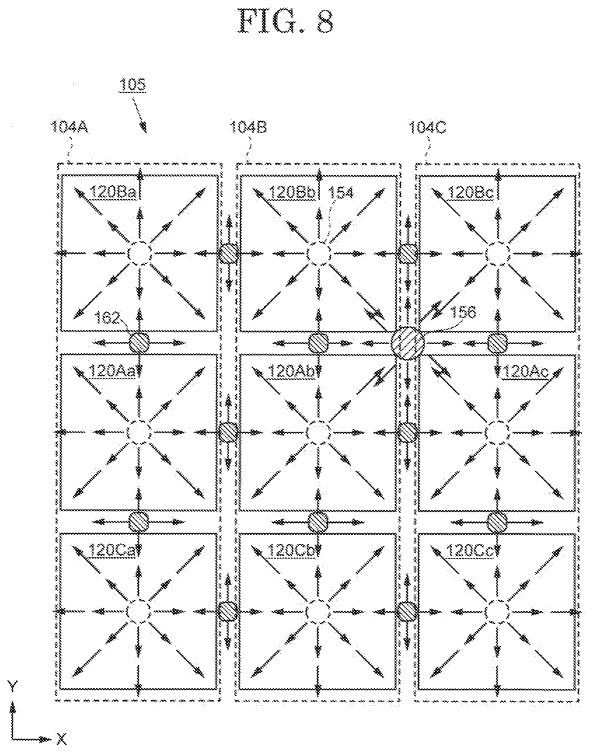

FIG. 8 shows a plan view of a pixel 105 of the liquid crystal display device of the present embodiment. As shown in FIG. 8, in this embodiment, the protruding portions 162 are arranged in regions between opposing sides of adjacent pixel electrodes. For example, the protruding portions 162 are arranged between one side of the first pixel electrode 120Aa and one side of the second pixel electrode 120Ba, which is adjacent to this side. This region between pixels is the region overlapping the region DR where the liquid crystal molecules aligned from both sides interfere with each other, causing the orientation state to become unstable and orientation disorder is likely to occur. It is possible to prevent the occurrence of orientation disorder by the action of its orientation-regulating force, by providing the protruding portion 162 in the region overlapping this region DR or in the region between pixels close to the region DR.

In this embodiment, the protruding portion 162 is not arranged in the region between pixels where the corners of the four pixel electrodes are adjacent to each other. However, this region between pixels is wider than the region where one of the sides of the two pixel electrodes is adjacent to each other, so the interaction of liquid crystal molecules is weakened and the liquid crystal molecules are aligned from the four or eight directions opposite each other, making it relatively difficult for orientation disorder to occur. Therefore, as shown in FIG. 8, by providing the protruding portions 162 in the regions between adjacent sides of the adjacent pixel electrodes, the occurrence of orientation disorder can be prevented, and image quality can be improved.

The liquid crystal display device of the present embodiment is similar to that in the first embodiment except that the configuration of the protruding portion 162 is different, and the same advantageous effects are achieved. Thereby, the image quality can be improved in a display that combines reflection mode and transmission mode.

### Fourth Embodiment

This embodiment shows a form in which the configuration of the protruding portion differs from the third embodiment. In the following description, details will focus on the parts that differ from the third embodiment, and common parts will be omitted from the explanation as appropriate.

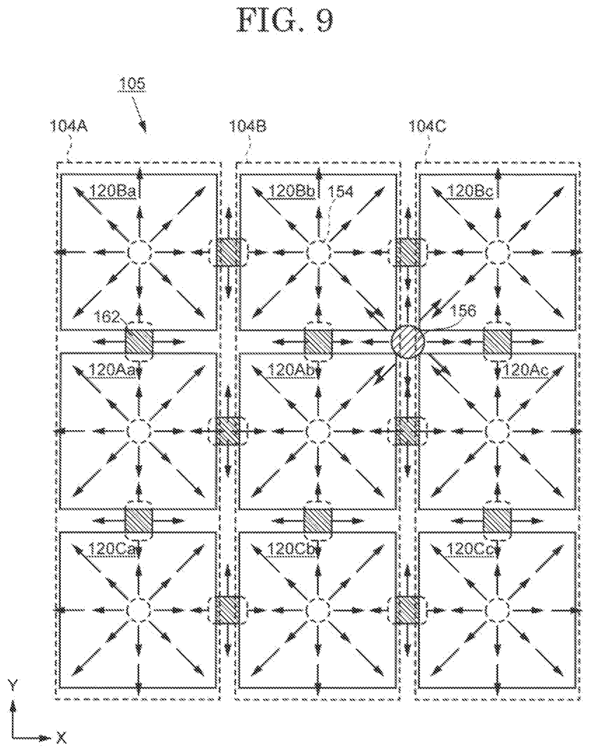

FIG. 9 shows a plan view of a pixel 105 of the liquid crystal display device of the present embodiment. As shown in FIG. 9, in this embodiment, the protruding portions 162 are arranged in regions between opposing sides of adjacent pixel electrodes and overlap one end of the pixel electrodes. For example, a wide protruding portion 162 is arranged between one edge of the first pixel electrode 120Aa and one edge of the second pixel electrode 120Ba adjacent to this one edge, and a portion of one edge of the first pixel electrode 120Aa and a portion of one edge of the second pixel electrode 120Ba overlap the protruding portion 162. In other words, some regions along one edge of the first pixel electrode 120A and some regions along one edge of the second pixel electrode 120B are disposed to be raised above the protruding portion 162. Such a structure can also prevent the occurrence of disclination in the region between the pixel electrodes, as in the third embodiment.

The liquid crystal display device of the present embodiment is similar to that in the third embodiment except that the configuration of the protruding portion 162 is different, and the same advantageous effects are achieved. Thereby, the image quality can be improved in a display that combines reflection mode and transmission mode.

### Fifth Embodiment

This embodiment shows a form in which the configuration of the protruding portion differs from the first embodiment. In the following description, details will focus on the parts that differ from the first embodiment, and common parts will be omitted from the explanation as appropriate.

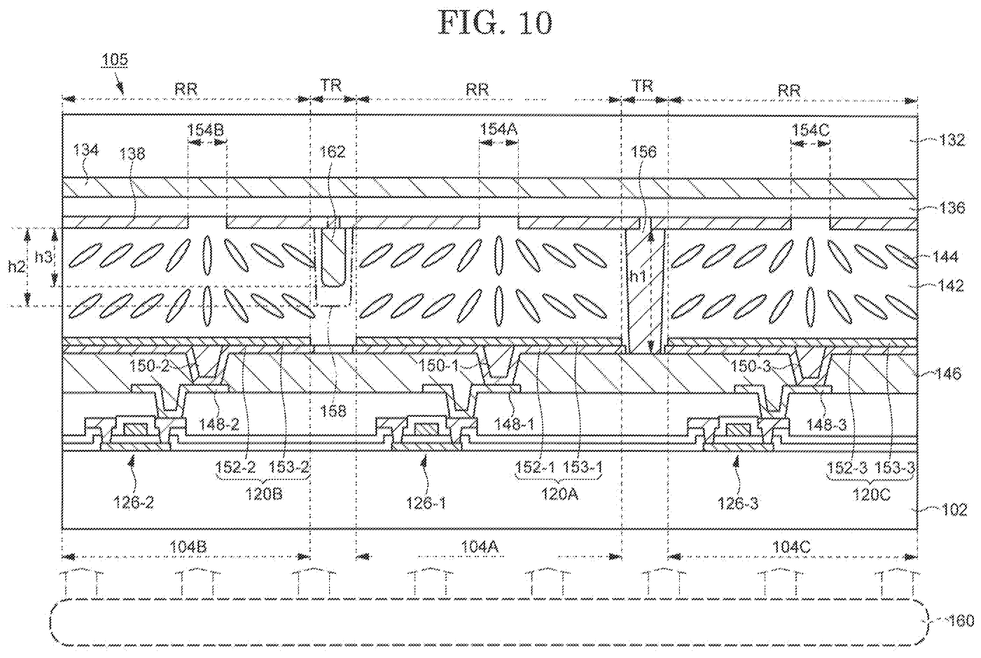

FIG. 10 shows a cross-sectional structure of a pixel 105 of the present embodiment. Specifically, a cross-sectional structure of the first sub-pixel 104A and partial cross-sectional structures of the second sub-pixel 1046 and the third sub-pixel 104C are shown. As shown in FIG. 10, the protruding portion 162 is arranged on the counter substrate 132 in the transparent region TR between the first pixel electrode 120A and the second pixel electrode 120B. In other words, the protruding portion 162 is arranged above the counter electrode 138 in the transmission region TR.

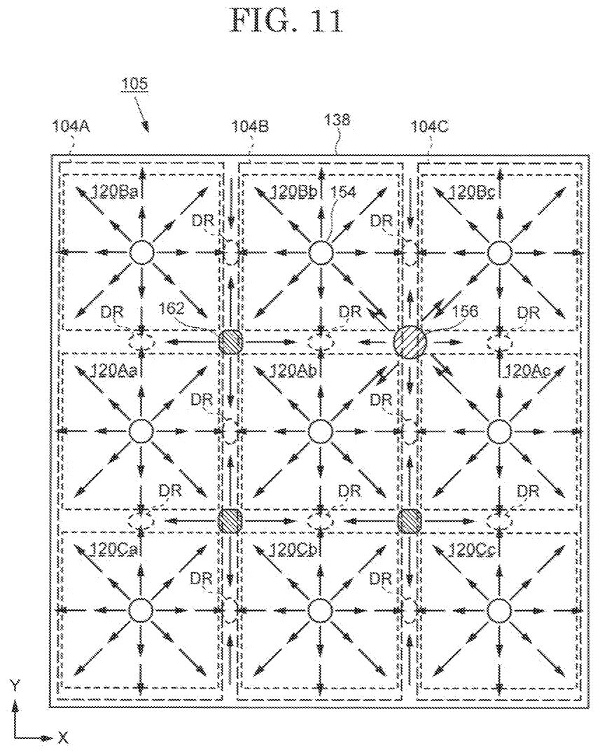

FIG. 11 shows a plan view of the pixels 105 of the liquid crystal display device. As shown in FIG. 11, a position of the protruding portion 162 in a plan view is on the top surface of the counter electrode 138, in the region between pixels where the corners of the four pixel electrodes are adjacent to each other. The height h3 of the protruding portion 162 is lower than the height h1 of the first spacer 156 and the height h2 of the second spacer 158, as shown in FIG. 10, so that it plunges into the liquid crystal layer 142 but does not reach the orientation membrane on the array substrate 102.

The liquid crystal display device of the present embodiment has the same configuration as that in the first embodiment except that the protruding portion 162 is arranged on the counter substrate 132. The protruding portion 162 on the counter substrate 132 is a starting point for the orientation of the liquid crystal molecules and acts to regulate the orientation state, as in the first embodiment. Thereby, the image quality can be improved in a display that combines reflection mode and transmission mode.

### Sixth Embodiment

This embodiment shows a form in which the configuration of the protruding portion differs from the fifth embodiment. In the following description, details will focus on the parts that differ from the fifth embodiment, and common parts will be omitted from the explanation as appropriate.

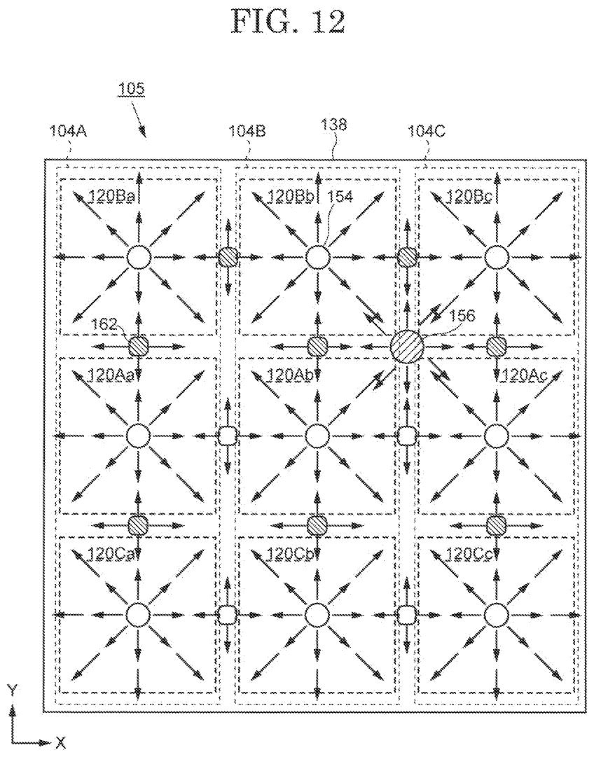

FIG. 12 shows a plan view of a pixel 105 of the liquid crystal display of the present embodiment. As shown in FIG. 12, the protruding portions 162 in a plan view are arranged on the top surface of the counter electrode 138 and in a region between adjacent sides of adjacent pixel electrodes. For example, the protruding portion 162 is arranged so that it overlaps a region between one side of the first pixel electrode 120Aa and one side of the second pixel electrode 120Ba adjacent to this side. In this way, it is possible to prevent the occurrence of orientation disorder in the same manner as in the third embodiment, by arranging the protruding portions 162 arranged on the counter substrate 132 so that they overlap the region where orientation disorder is likely to occur.

The liquid crystal display device of the present embodiment has the same configuration as that in the third embodiment except that the protruding portion 162 is arranged on the counter substrate 132. The protruding portion 162 on the counter substrate 132 is a starting point for the orientation of the liquid crystal molecules and acts to regulate the orientation state, as in the third embodiment. Thereby, the image quality can be improved in a display that combines reflection mode and transmission mode.

### Seventh Embodiment

This embodiment shows a form in which the configuration of the protruding portion differs from the first embodiment. In the following description, details will focus on the parts that differ from the first embodiment, and common parts will be omitted from the explanation as appropriate.

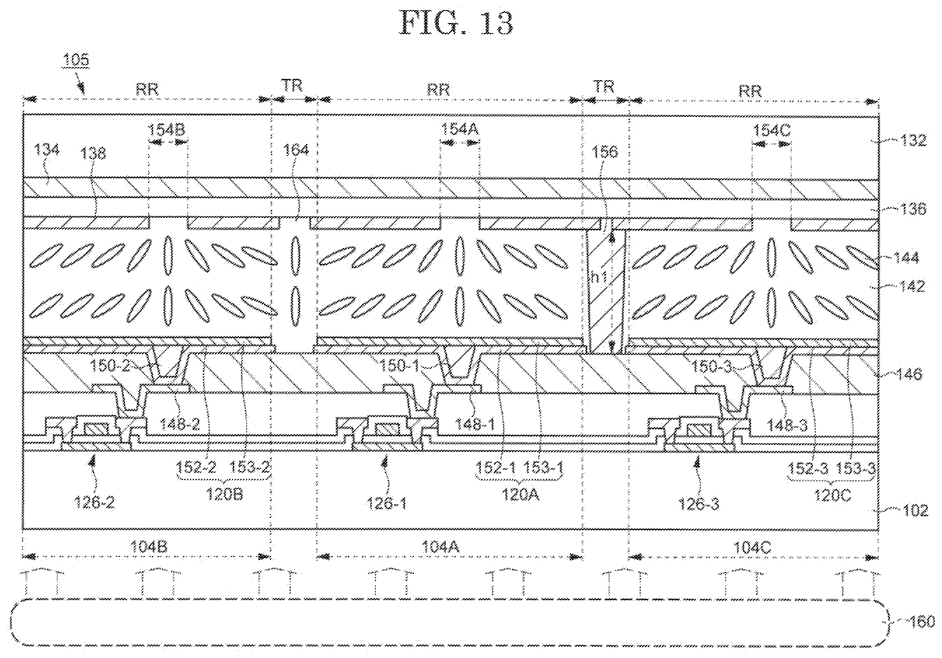

FIG. 13 shows a cross-sectional structure of the pixel 105 in the present embodiment, which shows the cross-sectional structure of the first sub-pixel 104A and partial cross-sectional structures of the second sub-pixel 104B and the third sub-pixel 104C. In this embodiment, the pixel array 106 is not disposed with any protruding portions, but in the transparent region TR, openings 164 are arranged in the opposing electrode 138. The liquid crystal molecules 144 in the region overlapping the opening 164 are less affected by the electric field generated between the pixel electrode and the counter electrode, however, the liquid crystal molecules 144 at the edge of the opening 164 and near the edge of the first pixel electrode 120A and the second pixel electrode 120B have their orientation strongly regulated by the intensity of the electric field in that region.

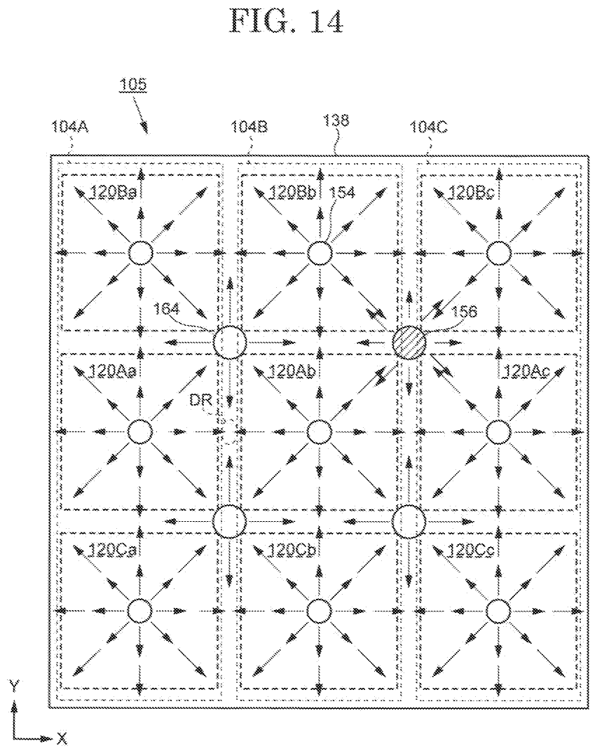

FIG. 14 shows a plan view of the pixel 105 of the liquid crystal display of the present embodiment. As shown in FIG. 14, the openings 164 in the counter electrode 138 are disposed in a position that overlaps the inter-pixel regions surrounded by the adjacent corners of the four pixel electrodes. For example, the opening 164 is arranged in an overlapping region with the region between pixels surrounded by the adjacent corners of the first pixel electrodes 120Aa, 120Ab, and the second pixel electrodes 120Ba, 120Bb.

The counter electrode 138 has a size that extends over the entire pixel array 106, but it is possible to concentrate the electric field at the edges of the openings 164, by providing the openings 164 so that they overlap the regions between pixels as described above. Thus, it is possible to form the regions where the electric field is concentrated, by providing the openings 164 through the counter electrode 138 in the regions between pixels where the orientation of liquid crystal molecules tends to become unstable thereby stabilizing the orientation state of the liquid crystal molecules.

It is possible to stabilize the orientation state of the liquid crystal molecules in the vicinity of the region between pixels, by providing the openings 164 in the counter electrode 138 thereby preventing the occurrence of orientation disorder. As a result, the generation of orientation disorder of liquid crystal molecules can be prevented even in the regions between pixels that are displayed in transmission mode, thereby suppressing the degradation of image quality.

The shape of the openings 164 in a plan view is not limited to the shape shown in the figure, and may be circular, triangular, diamond-shaped, cross-shaped, star-shaped, or polygonal, such as hexagonal or octagonal, in a plan view.

The liquid crystal display device of the present embodiment is similar to the liquid crystal display device of the first embodiment except that the openings 164 are arranged in place of the protruding portions 162, and the same effects are achieved. Thereby, the image quality can be improved in a display that combines reflection mode and transmission mode.

### Eighth Embodiment

This embodiment shows a form in which the configuration of the protruding portion differs from the seventh embodiment. In the following description, details will focus on the parts that differ from the seventh embodiment, and common parts will be omitted from the explanation as appropriate.

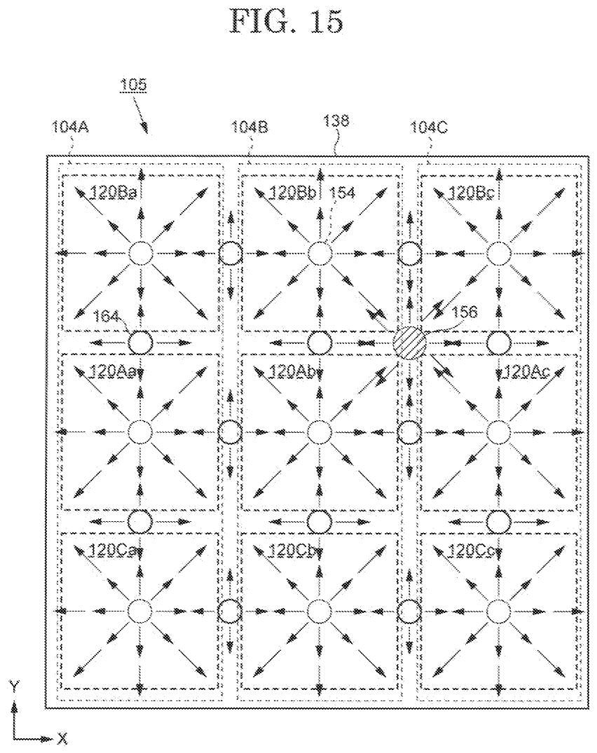

FIG. 15 shows a plan view of a pixel 105 of the liquid crystal display device of the present embodiment. As shown in FIG. 15, in this embodiment, the openings 164 in the counter electrode 138 are disposed in regions overlapping a region between opposing sides of one of the adjacent pixel electrodes. For example, the openings 164 are arranged in the region of the counter electrode 138 that overlaps the region between one side of the first pixel electrode 120Aa and one side of the second pixel electrode 120Ba, which is adjacent to this side. This region between pixels overlaps the region DR where orientation disorder is likely to occur. It is possible to prevent the occurrence of orientation disorder, by providing the openings 164 so that they overlap with this region DR or with the region between pixels close to the region DR.

The liquid crystal display device of the present embodiment is similar to that in the seventh embodiment, except that the configuration of the openings 164 is different, and the same effects are achieved. Thereby, the image quality can be improved in a display that combines reflection mode and transmission mode.

### Ninth Embodiment

The first and second embodiments have the protruding portions 162 on the array substrate 102, while the fifth and sixth embodiments have the protruding portions 162 on the counter substrate 132 to prevent the occurrence of orientation disorder of the liquid crystal molecules. Although these embodiments have a structure in which both protruding portions 162 and first spacers 156 are disposed, it can be expected that increasing the number of first spacers 156 in place of protruding portions 162 will also suppress the occurrence of orientation disorder of the liquid crystal molecules. However, since increasing the number of first spacers 156 too much will increase the repulsive force of the liquid crystal cell and is undesirable, this embodiment has a structure in which the occurrence of orientation disorder of liquid crystal molecules is prevented by providing openings 164 in the regions where liquid crystal orientation control is not extended by the first spacers 156.

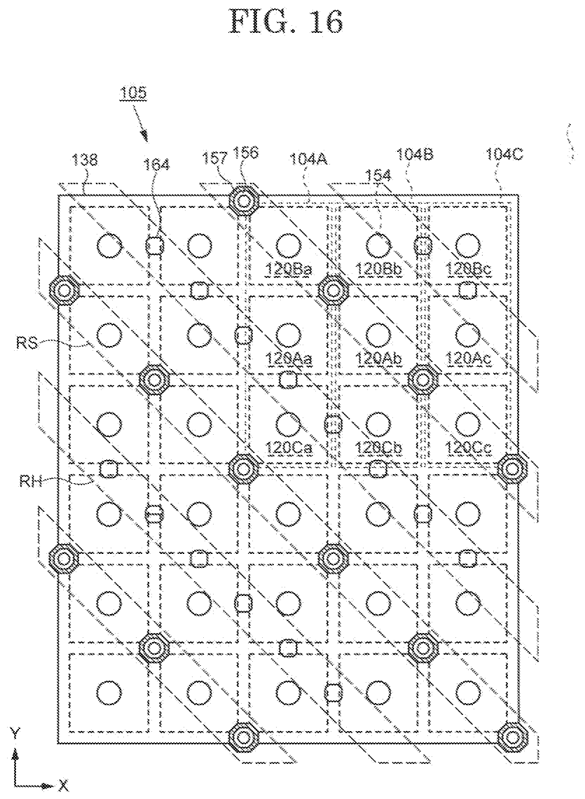

FIG. 16 shows a plan view of a pixel 105 of the liquid crystal display device of this embodiment. As shown in FIG. 16, in this embodiment, the first spacers 156 are disposed and the region RS in which the orientation state of the liquid crystal molecules is regulated by the first spacers 156, and the region RH in which the orientation state of the liquid crystal molecules are regulated by the openings 164 in the counter electrode 138. Thus, it is possible to prevent the occurrence of orientation disorder over all of the pixels 105, and thus over the entire pixel array, by providing the openings 164 in the regions where the orientation state of liquid crystal molecules cannot be regulated by the first spacers 156. The openings 164 may have a long shape along the edges of the pixel electrodes 120.

There is no limitation on the arrangement of the first spacer 156, although it may be arranged at an angle of 45 degrees to the arrangement of the pixel electrodes, as shown in FIG. 16. Such the arrangement forms the region RS in the direction of 45 degrees. The openings 164 arranged in the counter electrode 138 should be arranged to fill the space between the regions RS to form the region RH.

Since the region near the first spacer 156 is a region where the orientation control of the liquid crystal molecules by the pixel electrode does not extend, a light shielding layer 157 may be disposed over the first spacers 156. This configuration can prevent light leakage and improve image quality (dynamic range).

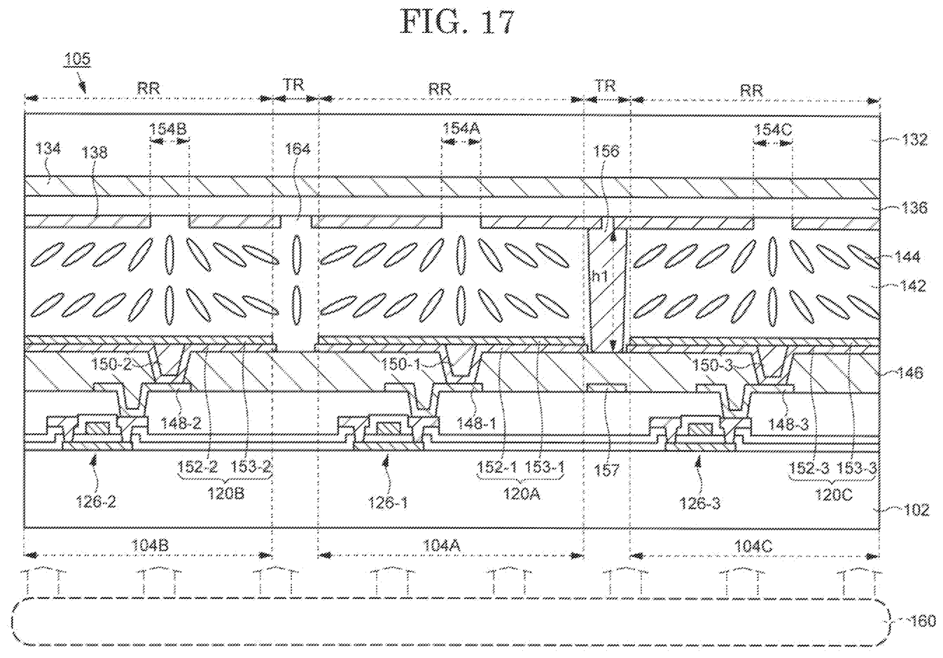

FIG. 17 shows a cross-sectional view of the pixel 105 of the liquid crystal display of the present embodiment. The cross-sectional structure of the pixel 105 is similar to the cross-sectional structure of the pixel shown in FIG. 13 (refer to the seventh embodiment). In this embodiment, the light shielding layer 157 is disposed overlapping the first spacers 156, as shown in FIG. 16. FIG. 17 shows an example where the light shielding layer 157 is disposed on the same layer as the connecting wirings 148-1, 148-2, 148-3. The light shielding layer 157 is not limited to the example shown in FIG. 17, and may be formed in a layer forming the switching element (transistor) 126 (a layer forming the gate electrode, a layer forming the source or drain electrode, or a wiring layer connected to these electrodes).

The liquid crystal display device of the present embodiment is similar to those in the fifth and sixth embodiments except that the protruding portions of the array substrate 102 are omitted, the number of first spacers 156 is increased on the counter substrate 132, and the openings 164 are arranged to fill the array, and the same effects are achieved. Thereby, the image quality can be improved in a display that combines reflection mode and transmission mode.

Each of the embodiments described above as embodiments of the present invention may be combined as appropriate to the extent that they do not contradict each other. Based on the liquid crystal display device of each embodiment, any addition, deletion, or design change of components, or any addition, omission, or change of conditions of processes made by a person skilled in the art as appropriate, is also included in the scope of the invention as long as it has the gist of the invention.

Other advantageous effects different from the advantageous effects provided by each of the embodiments described above, which are obvious from the description herein or which can be easily foreseen by a person skilled in the art, are naturally considered to be provided by the present invention.

What is claimed is:

1. A liquid crystal display device, comprising:
an array substrate including a pixel array arranged in a matrix of a plurality of pixel electrodes on an insulating layer;
a counter substrate arranged with a counter electrode facing the array substrate and overlapping the plurality of pixel electrodes;
a liquid crystal layer between the array substrate and the counter substrate;
a first spacer between the array substrate and the counter substrate; and
a protruding portion protruding into the liquid crystal layer,
wherein:
the counter electrode is disposed with openings in regions overlapping each of the plurality of pixel electrodes,
the protruding portion is arranged in a region between the electrodes of the plurality of pixel electrodes, and
a height of the protruding portion is lower than a height of the first spacer.

2. The liquid crystal display device according to claim 1, further comprising a second spacer between the array substrate and the counter substrate,
wherein:
the first spacer is in contact with both the array substrate and the counter substrate,
the second spacer is in contact with one side of the array substrate and the counter substrate, and
the height of the protruding portion is lower than a height of the first spacer and the second spacer.

3. The liquid crystal display device according to claim 1, wherein the protruding portion is disposed in a region surrounded by corner parts of four adjacent pixel electrodes of the plurality of pixel electrodes.

4. The liquid crystal display device according to claim 3, wherein each corner of the four pixel electrodes overlaps the protruding portion and protrudes along the protruding portion.

5. The liquid crystal display device according to claim 1, wherein the protruding portion is disposed between opposing sides of two adjacent pixel electrodes among the plurality of pixel electrodes.

6. The liquid crystal display device according to claim 5, wherein a portion of each of the two adjacent pixel electrodes overlaps the protruding portion and protrudes along the protruding portion.

7. The liquid crystal display device according to claim 2, wherein the protruding portion protrudes from the array substrate into the liquid crystal layer.

8. The liquid crystal display device according to claim 3, wherein the protruding portion protrudes from the counter substrate into the liquid crystal layer.

9. A liquid crystal display device, comprising:
an array substrate including a pixel array having a plurality of pixel electrodes arranged in a matrix on an insulating layer;
a counter substrate opposite the array substrate and including a counter electrode overlapping the plurality of pixel electrodes; and
a liquid crystal layer between the array substrate and the counter substrate,
wherein the counter electrode includes first openings overlapping each of the plurality of pixel electrodes, and second openings overlapping regions between pixels of the plurality of pixel electrodes.

10. The liquid crystal display device according to claim 9, wherein each of the second openings are disposed in the region surrounded by corners of four adjacent pixel electrodes in the plurality of pixel electrodes.

11. The liquid crystal display device according to claim 9, wherein each of the second openings are disposed in a region overlapping a region between electrodes of two adjacent pixel electrodes in the plurality of pixel electrodes.

12. A liquid crystal display device, comprising:
an array substrate including a pixel array having a plurality of pixel electrodes arranged in a row and column direction on an insulating layer;
a counter substrate opposite the array substrate and including a counter electrode overlapping the plurality of pixel electrodes;
a liquid crystal layer between the array substrate and the counter substrate; and
a first spacer between the array substrate and the counter substrate, wherein
the counter electrode includes first openings overlapping each of the plurality of pixel electrodes, and second openings overlapping region between pixels of the plurality of pixel electrodes,
the first spacer is arranged in a first region between pixel electrodes of the plurality of pixel electrodes and in a direction along a diagonal of the pixel array, and
the second openings are arranged in a region between the plurality of pixel electrodes and between the pixel electrodes along the array of the first spacer.
